(19) United States
(12) Patent Application Publication
(10) Pub. No.: US 2008/0173404 A1
(43) Pub. Date: Jul. 24, 2008

(54) Segmented adhesive dispenser sheet system

(76) Inventor: Samuel L. Guillory, New York, NY (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/656,232

(22) Filed: Jan. 22, 2007

(51) Int. Cl. B32B 37/12

(52) U.S. Cl. 156/510

(57) ABSTRACT

A segmented adhesive dispenser in the form of a sheet or roll has a polymeric sheet coated with easy to release coating. Adhesive segments carried by the polymeric sheet are removed from the segmented adhesive dispenser and applied to gift-wrapping wrapped on a gift box. The adhesive segments have substantially completely coated adhesive coverage on the polymeric sheet contacting side. The opposite side of the polymeric sheet is uncolored or decoratively colored, printed or patterned. The adhesive segment has a tab provided on one corner or edge, which is removed after placing the adhesive segment on the gift-wrapping. Upon removal of the tab, the adhesive coating directly below the tab secures the adhesive segment to the gift-wrapping without wrinkles or dangling unsightly portions on the gift-wrap. Removal of the adhesive segment, and its application to the gift-wrapping is readily carried out by a one-hand operation.

### BACKGROUND OF THE INVENTION

1. Field of the Invention

The present invention relates dispensing of adhesive backed articles; and, more particularly, to an adhesive dispensing sheet comprising a plurality of adhesive backed segments, each of which is pre-cut and appointed to securely adhere to gift-wrapping paper.

2. Description of the Prior Art

Wrapping gift packages require clean folds and clean-securing adhesives to create an attractive presentation. While a number of adhesive tapes are commercially available, these continuous long-length elements must be cut using one hand while the folded gift-wrap is held in place with the other hand. This procedure oftentimes makes difficult the presentation of an attractive gift package. Numerous prior art patents disclose adhesive tapes; but there is no disclosure of attractive pre-cut adhesive tape segments that are readily available for wrapping gifts.

U.S. Pat. No. 4,355,720 to Hofberg et al. discloses a package for dispensing precut tape segments. The package includes a plurality of pieces of sheet material having first and second ends and an upper surface with a smooth texture that facilitates retention of tape in a releasable manner. The tape has an adhesive backing. It is releasably attached to a sheet and is adapted for use when attaching diapers. The precut segment tapes have no adhesive at one end. This tape is unsuited for securing wrapping paper, since the portion of the tape segment without adhesive dangles without attachment, and a gift package wrapped therewith would be unattractive.

U.S. Pat. No. 5,511,689 to Frank discloses a dispensing device for adhesive-backed articles. This adhesive-backed article has a first adhesive disposed on a portion of its bottom surface that bonds the top surface of the backing layer. The top surface of the adhesive-backed article is bonded to the bottom surface of the support layer by a bond formed by a second adhesive disposed on a portion of the bottom surface. The bond formed between the top surface of the adhesive backed article and the bottom surface of the support layer is stronger than the bond between the bottom surface of the adhesive-backed article and the top surface of the backing layer. When the support layer is separated from the backing layer, the adhesive-backed article remains affixed to the support layer. Moreover, the bond formed between the top surface of the adhesive-backed article and the bottom surface of the support layer is weaker than a bond formed between the adhesive on the bottom surface of the adhesive backed article and a surface to which it is adhered when the adhesive-backed article is applied to an application surface and the support layer separates from this surface. The adhesive-backed article, which remains bonded to the application surface, is a bandage secured in a package and transported to the site of an injury for bonding the bandage to skin. This adhesive backed article is structurally and functionally distinct from an adhesive strip especially suited for gift-wrapping.

U.S. Pat. No. 5,516,581 to Kreckel et al. discloses a removable adhesive tape. This removable adhesive tape comprises a highly extensible and substantially inelastic backing and a layer of pressure-sensitive adhesive. The backing has a high tensile strength, and a lengthwise elongation at break of about 150% to 1200% with less than about 50% elastic recovery after stretching. The adhesive is normally tacky; and is coated on one surface of the film backing. Preferably, the adhesive is highly extensible. It does not separate from the backing during stretching, and has higher cohesion than adhesion to any suitable substrate. After being applied to a substrate, the adhesive tape becomes firmly bonded, but can be easily removed without damaging the substrate by simply stretching it in a direction substantially parallel, i.e., less than about 35°, to the surface of the substrate. The tape ruptures at the adhesive interface due to the extensive stretchability of a highly extensible substantially inelastic backing layer. This property prevents use of the tape for securing wrapping paper in a gift-wrap since the adhesive will delaminate when subjected to tight wrapping events. The tape is designed to be removable, while the expectation of a gift-wrapping adhesive is exactly the opposite.

U.S. Pat. No. 6,177,163 to Blok et al. discloses a markable repositionable adhesive sheet-dispensing roll for use in an industrial setting. Adhesive sheet assemblies comprise a continuous carrier in roll form with a series of longitudinally spaced adhesive sheets on the carrier. The adhesive sheet assembly within a dispenser is comprised of a carrier with a series of adhesive sheets on one face of carrier. Each adhesive sheet has a cover piece for peeling an adhesive sheet from the carrier. The front side of the adhesive sheet, facing away from the carrier, is capable of receiving markings. Preferably, at least 40 percent of the total length of the outer peripheral edge of each cover piece is substantially in registration with the outer peripheral edge of the adhesive sheet to which it is adhered. Each adhesive sheet comprises a flexible polymer film, polymer-reinforced sheet or cloth, and is capable of being removed from a substrate to which it is adhered without leaving an adhesive residue on the substrate. The adhesive sheets are provided in a roll with each adhesive sheet having a cover sheet that contains no adhesive coating; this facilitates easy removal of the adhesive sheet from the roll. The cover sheet can be used for printing information. Such an adhesive sheet, with associated cover sheet, is not well suited to secure wrapping paper, since the adhesive sheet is not completely coated with the adhesive and the coversheet would likely dangle unattached from a wrapped gift.

U.S. Pat. Nos. 6,403,188 and 6,649,239 to Donahue disclose a multi-layer sheet of repositionable posting sheetlets. A multi-layer sheet has individual posting sheetlets in a side-by-side relationship. The multi-layer sheet comprises a base release sheet, the posting sheetlets in a flat sheet form, and a removable cover sheet. The posting sheetlets are loosely held together in a manner whereby an individual posting sheetlet is easily removed and used as a base. Each posting sheetlet in the multi-layer sheet has an adhesive partially covering each face thereof in approximate aligned areas of the respective faces. A front face or a back face of the individual posting sheetlet is adhered to a substrate while an opposed face holds an item for posting. In use, an individual posting sheetlet is readily removed from the multi-layer sheet and a cover panel is removed from the posting sheetlet to fully expose the front face and the back face of the individual posting sheetlet. These adhesive coated sheets are coated entirely or partially with an adhesive layer on both surfaces. One side of the sheetlet attaches to a surface, while its rearside attaches to a posted note. Due to the presence of adhesive on both sides of the sheetlet, this adhesive coated sheet is unsuited for securing wrapping paper.

U.S. Pat. No. 6,541,089 to Hamerski et al. discloses a stretch releasing adhesive tape with an integral pull-tab. An elongated length of a single or double-sided stretch releasing adhesive tape is cut to a selected length with integral pull-tabs for stretch removing the tape from a substrate. The stretch releasing adhesive tape can be provided as long strips or in a roll form. The stretch releasing adhesive tape has a first surface and a second non-adhesive surface. The first surface comprises one or more adhesive regions and one or more non-adhesive regions arranged along the longitudinal axis. Since the stretch releasing tape is highly stretchable it cannot be used to secure wrapping paper, which is normally wrapped in a tight configuration. Also the non-adhesive coated regions are unattached and dangle freely, producing an unattractive appearance when a gift package has wrapping paper secured thereto with this releasing adhesive tape.

U.S. Pat. No. 6,544,639 to Luhmann et at. discloses an adhesive tape strip. This adhesive tape strip has a rereleasable adhesive bond, which can be removed from a bonded joint by pulling in the direction of the bond plane. The bonding area of the adhesive tape strip decreases in the region of the grip tab or in the pressure-sensitive adhesive region directly bordering the grip tab as the tab is pulled. This is a stretchable tape having a progressively decreasing width from the tab portion. Pulling the tape by gripping the wide width portion results in high levels of stress at the reduced width portions, and progressive tape separation. This stretchable tape is not a tape that is useful for gift box packaging operations.

U.S. Pat. No. 6,617,000 to Denny et al. discloses adhesive labels and manufacture thereof. Adhesive labels are manufactured by cutting windows in an upper layer of a support web through to a lower silicone coated material. Folded leaflets are then adhered by lines of adhesive to the support web and the combination is die-cut to form individual adhesive labels with part of the die-cut folded leaflet extending beyond an edge of a base label formed from the window in the support web. The adhesive labels have a folded leaflet attached to the labels. Such folded leaflets would be unsightly if the adhesive label were used to secure wrapping paper. The label does not present an adhesive tape that well suited for securing wrapping paper to a gift box.

U.S. Pat. No. 6,756,102 to Galo discloses adhesive tape having serial segments with non-adherent gripping elements. This adhesive tape of indeterminate length is capable of separation into serial segments of finite length, with each segment including a gripping element established by a non-adhesive area contiguous with one terminal end of the segment. Serial segments are spaced from each side edge of the segment so as to assure secure adherence of the segment from end to end of the segment to a juxtaposed surface and to facilitate selected release of the terminal end from the juxtaposed surface. The roll of tape is coated with adhesive except in regions that define a tab portion. The tape is also perforated for easy tearing comprising the non-adhesive coated tab portions at each end. If this tape were to be used to secure wrapping paper, the non-adherent tab will dangle, producing an unsightly appearance on the gift package.

U.S. Pat. No. 6,912,798 to Blau et al. discloses removable boxing tape. A length or roll of tape is designed to be easily removed. The tape has a substrate or a film on which two opposingly located adhesive sections are formed. A non-adhesive section is also located on the substrate between the adhesive sections. The non-adhesive section forms a graspable handle at one end of the substrate, which makes the tape easier to remove. The non-adhesive section may be substituted with a low strength adhesive section as well. The adhesive tape used has portions, which are not coated with an adhesive so as to form a handle or a tab. The tape is pulled using this handle or tab. Since the boxing tape is not coated with adhesive everywhere, these non-adhesive portions will dangle if this tape were to be used to secure wrapping paper, providing an unsightly appearance.

U.S. Published Patent Application No. 2003/0039786 to Milliom et al. discloses a process for making labels having a non-adhesive portion. This adhesive label is produced by a process that includes the steps of providing a web consisting of an adhesive label substrate having a face material, an adhesive layer and a liner. The web has a web width and a web direction. A plurality of non-adhesive strips is positioned between adhesive portions in parallel alignment with the web direction. The web is positioned in a label conversion machine wherein the web is continuously pulled through the conversion machine in the web direction. A plurality of labels are configured on the web wherein a first portion of each label overlays a non-adhesive strip and a second portion of each label overlays an adhesive portion. The labels are cut on the web and printed with indicia used in food safety labeling systems. The labels are then further processed into individual rolled strips for use in food safety labeling systems wherein the back surface of each label has a first non-adhesive portion and a second adhesive portion. The non-adhesive tab portion will dangle freely if this label is used to secure a wrapping paper. Such a marking label is structurally and functionally distinct from an adhesive segment adapted to secure a wrapping paper.

U.S. Published Patent Application No. 2004/0191459 to Driesten discloses reusable closures for packages and methods of making and using the same. Adhesive articles, particularly useful as reusable closures, comprising a moisture resistant substrate and a removable adhesive covering at least a portion of the substrate surface, the adhesive having a Moist Loop Test result of at least about 25 N/25 mm at a test plate temperature of 5° C. The closure may also include a permanent adhesive covering another portion of the substrate surface. The adhesive articles provide easy application to packages and exhibit good adhesion performance in the presence of moisture, such as from refrigerated or frozen food packaging. The adhesive used in the closure is reusable and does not entirely cover the closure since the tab area is uncoated with the adhesive. If these closure strips are used for securing the wrapping paper, they will not hold since the releasable adhesive is weak. The tab portion is unattached and dangles, producing an unsightly appearance.

U.S. Published Patent Application No. 2005/0084641 to Downs et al. discloses perforated adhesive dispensing sheets. An adhesive dispensing sheet includes a plurality of pressure sensitive adhesive segments disposed on a carrier material. The adhesive segments are separated from one another on the carrier material by perforations. The perforated adhesive dispensing sheet permits a single adhesive segment to be carefully torn away from and thereby detached from the remaining adhesive segments on the adhesive carrier sheet, allowing easy placement of the torn single adhesive segments. With this arrangement, a pressure-sensitive adhesive segment may be dispensed onto any item at a proper location without damaging the adhesive segment or the remainder of the adhesive dispensing sheet. The adhesive segments are releasably attached to a release agent-coated carrier sheet, and are further protected by a cover sheet. There are no tabs present in the adhesive segments for easy removal of the adhesive segments from the carrier sheet. The perforations are in the carrier. Accordingly, the carrier also comes along with the adhesive segment, which must be peeled from a closely fitting carrier sheet. This adhesive segment is simply a segment of the adhesive with no backing tape. It cannot be used to reliably secure gift-wrappings.

U.S. Published Patent Application No. 2005/0170127 to Whitmond et al. discloses a stamp sheetlet. This foldable stamp sheet includes a backing sheet with at least one label on the sheet. The label has an adhesive backing that allows it to adhere to the backing sheet in a non-permanent manner. Each label has a scored section along a midline of the label, and at least one stamp is formed on each label. There is at least one pull tab on the sheet. A plurality of pull tabs are positioned in an area where the sheet is to be folded when a pull tab is removed from the sheet. With this arrangement, a postage stamp containing sheet can be folded to a credit card size packet without damaging the stamps or the information printed in removable tabs. This arrangement is structurally and functionally distinct from decorative adhesive strips that secure wrapping paper.

U.S. Published Patent Application No. 2006/0073300 to Pearson et al. discloses tape sheet pads and a dispenser, and a method of dispensing individual tape sheets from such pads. The dispenser comprises a base having transversely spaced first and second major surfaces. First and second longitudinal ends define a length and first and second lateral sides define a width. The tapes are provided with adhesives that have two different levels of adhesiveness and are peeled one at a time from a stack where the adhesive coated tape sheets lay one above the other. These tape sheets are similar to post it notes and are structurally and functionally distinct from adhesive tapes suited for securing wrapping paper. Adhesives which are present have two different levels of tackiness, which would likely cause unreliable attachment to wrapping paper.

U.S. Published Patent Application No. 2006/0107576 to Hirst discloses a produce label with a folded tab-lift and method of and apparatus for making same. This label is applied to produce and is provided with a novel folded tab-lift, allowing the consumer to easily remove the label. The folded tab-lift is twice as thick as the body of the label and has upper and lower surfaces that are free of adhesive. This label is a product label with a head portion that is folded to produce a tab that can easily lift the label from the product to which it is applied. The tab is not used to peel the label from the label dispensing sheet, but is used to lift the label from the product to which it is applied. The folded tab is created after the label is peeled from the carrying sheet. This oval shaped label is unsuited for securing wrapping paper due to its awkward shape and design. The folded tab with no adhesive would dangle from a gift-wrapping, creating an unsightly appearance.

U.S. Published Patent Application No. 2006/0147667 to Salmon discloses pre-cut duct tape shapes. The adhesive includes predetermined shaped single-sided adhesives adapted to cover and conform to the shape of corresponding adhesive element receiving areas. The predetermined shaped single-sided adhesives are removably stackable and dispensable using several disclosed methods. Duct tape is pre-cut to different geometric shapes. The pre-cut duct tape does not suggest a decorative adhesive tape especially suited to secure wrapping paper.

U.S. Published Patent Application No. 2006/0147668 to Hirose et al. discloses a label sheet. A unit label on a first tier is connected to a unit label on a second tier by a connecting portion in the vicinity of the lower right corner portion of the first tier unit label. The strength of the connecting portion is set so that the connecting portion is separated when a corner portion of the second tier unit label is in a raised state, following peeling of the first tier unit label from a release sheet. A row of labels in the label sheet is interconnected by weak links that break and project, enabling easy grasping of an adjacent label. These labels are computer printed labels or information sheets. The labels thus produced are not decorative and are not suited for securing wrapping paper.

Foreign Patent Application No. GB2316618 to Valois et al. discloses a device for dispensing pieces of adhesive strip. The device, which is particularly suited for dispensing dressings, comprises pieces of pressure-sensitive adhesive strip at least a part of each strip being releasably adhered to the non-stick front face of a backing sheet. The sheet itself is provided on its other face with means such as double-sided adhesive tape for securing it to a holding element such as a table or trolley, thereby enabling one-handed removal of the dressings, etc. The adhesive strip dispensed is a medical bandage and is not a decorative adhesive tape for securing wrapping paper used to cover a gift box. The adhesive strip of the '618 patent disclosure has a pad or compress in the middle, which reduces the attachment capability of the adhesive strip when used for securing a wrapping paper.

Notwithstanding the efforts of prior art workers to construct a dispenser for adhesives, there clearly exists a need in the art for decorative gift wrap securing tapes that can be easily removed from a roll or a sheet using a single hand, so that gift wrap may be attractively and reliably secured in a time and cost efficient manner.

### SUMMARY OF THE INVENTION

The present invention provides an adhesive dispenser comprising a plurality of adhesive segments, each of which has a surface substantially covered by an adhesive material and is pre-cut and especially adapted to adhere reliably to wrapping paper. The dispenser, which may be a sheet or a roll, contains a plurality of adhesive segments. Each of the segments is provided with a tab covering the adhesive surface to facilitate gripping and removal. After the adhesive segment is applied to a gift package, the tab is peeled off and the entire surface of the adhesive segment that is coated with the adhesive secures the package without any wrinkles in the adhesive segment, providing an attractive presentation. Removal of the tab provides an adhesive tape that completely secures the wrapped package without adhesive free areas dangling from the adhesive tape. Advantageously, with this arrangement, decorative gift wrap securing tapes can be easily removed from a roll or a sheet using a single hand, enabling gift wrap to be attractively and reliably secured in a time and cost efficient manner.

In one aspect, the invention comprises a segmented dispenser system, comprising pre-cut segments of adhesive or tape that adhere to wrapping paper and the like and are conveniently placed on a dispenser sheet, which may be a plain sheet or a roll. The segmented adhesive dispenser system broadly comprises: (i) a plurality of adhesive segments, each of the segments having a surface substantially covered by an adhesive material and being pre-cut and appointed to adhere to wrapping paper; (ii) said plurality of adhesive segments contacting a segmented adhesive sheet with the adhesive surface of the adhesive segments contacting an easy-to-release surface of the dispenser sheet or roll; (iii) one corner or edge of said adhesive segment being provided with an easy-to-release strip that functions as a tab for easy removal of the adhesive segment from the segmented adhesive dispenser sheet, (iv) the adhesive segment being a completely covered adhesive tape adapted to secure a wrapping gift box or wrapping paper without any adhesive-free dangling areas upon removal of the tab-release strip, and (v) said plurality of adhesive segments being contained within a dispenser. The adhesive surface of each segment is adapted to adhere to wrapping paper while the tab surfaces facilitate grasping of the adhesive segments during removal from the segmented adhesive dispenser. The acts of removing of the adhesive segment from the segmented adhesive dispenser and applying the adhesive segment to a gift wrap can be carried out with a single hand, while the other hand is used to secure the gift wrapping on a gift box. The tab is removed after the gift-wrap is secured by the adhesive segment. This exposes the adhesive under the tab in the adhesive segment, securing the gift-wrap without any crease or wrinkles in the adhesive segment. No unattached dangling portions are present in the adhesive segment that secures the gift wrapping. Consequently, the segmented dispenser system facilitates presentation of an attractive gift package.

In another aspect, the segmented adhesive dispenser system provides an arrangement of pre-cut adhesive segments for wrapping presents and the like. The arrangement of pre-cut segments facilitates removal of pre-cut tape segments and the disposal thereof in positions that reliably secure wrapping paper in place. Wrapping can become cumbersome when one is trying to position a length of wrapping paper around a present, while at the same time attempting to retrieve tape from a conventional dispenser. With the segmented adhesive dispenser system, the user simply grasps a pre-cut tape section and adheres it to the wrapping paper. The segmented adhesive dispenser system can comprise pre-cut, transparent tape that is devoid of color. Alternatively, each of the adhesive segments may exhibit a distinctive color, or may have various distinctly different decorative patterns thereon.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 is illustrates a top planer view of the segmented adhesive dispenser system with a plurality of adhesive segments.

### DETAILED DESCRIPTION OF THE INVENTION

This invention relates to a segmented adhesive dispenser system that provides adhesive segments for more efficient gift-wrappings using wrapping paper. A segmented adhesive dispenser has a sheet or roll that carries a plurality of adhesive segments, which are substantially entirely coated with adhesive on one side and may be transparent or printed with attractive colors, designs or patterns on the opposite side. These adhesive segments are removably attached to the segmented adhesive dispenser sheet or roll with the adhesive side of the adhesive segment facing the release agent coated segmented adhesive dispenser sheet or roll. This release agent may be in the form of a wax coating, or a silicone coating, or the dispenser sheet may be made from a polymeric sheet that permits easy release of adhesive segments such as Mylar, silicone or other polymeric sheets.

Generally stated, the invention involves pre-cut segments of adhesive or tape that adhere to wrapping paper and the like. The segmented adhesive dispenser system broadly comprises: (i) a plurality of adhesive segments, each of the segments having a surface substantially covered by an adhesive material and being pre-cut and appointed to adhere to wrapping paper; and (ii) said plurality of adhesive segments being contained within a dispenser, which may be a sheet or a roll. Each of the adhesive segments is provided with an easy to peel tab that covers the corner or an edge of the adhesive segment. The tab facilitates grasping of the adhesive segments and its removal from the segmented adhesive dispenser, which may be in the form of a sheet or a roll. Upon peeling of the tab, the adhesive coated entire surface of each adhesive segment is adapted to readily adhere to wrapping paper with no unsightly dangling portions.

The segmented adhesive dispenser sheet system provides a pre-cut adhesive for wrapping presents and the like. As such, the pre-cut segments provide the ability for a user to simply remove a pre-cut segment of tape and readily place the tape segment in a position that holds the wrapping paper in place. Wrapping can become cumbersome when one is trying to position a length of wrapping paper around a present, while at the same time attempting to retrieve tape from a conventional dispenser. With the segmented adhesive dispenser sheet system, the user can simply grasp a pre-cut tape section using the peelable tab provided at the corner or edge of each adhesive segment and adhere it to the wrapping paper. The segmented adhesive dispenser system may comprise pre-cut, transparent tape that is devoid of color. Alternatively, each of the adhesive segments may exhibit a distinctive color, or may have a variety of different decorative patterns thereon.

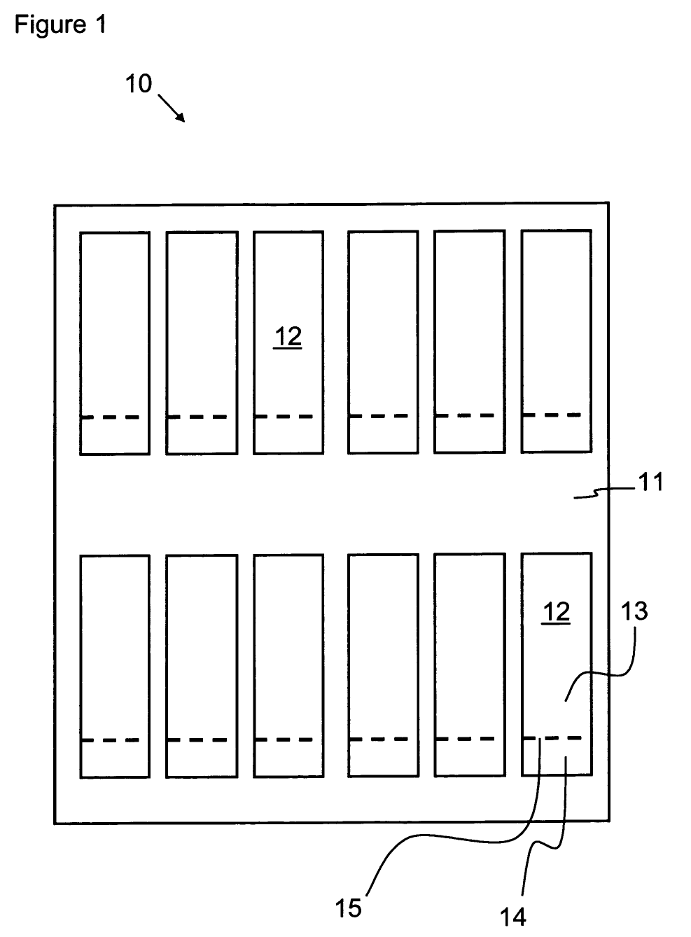

FIG. 1 illustrates a top planer view of the segmented adhesive dispenser system, shown generally at 10. The segmented adhesive dispenser system 10 comprises a plurality of adhesive segments 12 having an adhesive surface 13, which covers the entire surface of the adhesive segment contacting the dispenser sheet 11. The adhesive layer faces the dispenser sheet adhesive segments 12, which are each pre-cut in size, and are appointed for adhering to paper, such as wrapping paper. The pluralities of adhesive segments 12 are contained within a dispenser 11. Each of the adhesive segments is provided with a tab 14, which is readily peelable or tearable. Peeling or tearing of tab 14 exposes the entire adhesive coating of the adhesive segment for secure attachment of a wrapping paper. Tab 14 facilitates convenient grasping of each adhesive segment 12, and is shown by way of dotted line 15, since the releasable tabs are between the adhesive segment and the dispenser and will not be visible in this top view. In the embodiment of FIG. 1, dispenser 11 is shown as a sheet; however, dispenser 11 may alternatively comprise a strip, layered strip, packet, or roll.

The key components of the segmented adhesive dispenser system include, in combination, the features set forth below:
1. a segmented dispenser in the form of a sheet or a continuous roll of a polymeric sheet;
2. the segmented dispenser having a surface that is coated with an easy-to-release coating or made from a polymeric sheet such as a polyester (Mylar), or other suitable polymeric material with a silicone, wax coating exhibiting superior release properties;
3. the segmented dispenser comprising a plurality of adhesive segments;
4. the adhesive segments being transparent or opaque;
5. the adhesive segments having a pair of opposing surfaces, the first surface being substantially entirely covered with an adhesive layer adapted to secure wrapping paper while the second surface having no color or, alternatively, a decorative color, pattern-printed text or graphics, and the like;
6. the adhesive surface of the segment contacting the easy-to-release surface of the segmented dispenser;
7. a corner or edge of the adhesive segment being provided with an easy-to-release tab 14, providing a place for grabbing the adhesive segment underneath the tab and easily releasing an adhesive segment during wrapping of a gift; and
8. said adhesive segment providing securing means for gift-wrapping paper that is completely covered with adhesive, having no adhesive-free dangling areas upon removal of said easy to release tab at the corner or edge of said adhesive segment; whereby the gift can be wrapped quickly and easily by a plurality of decorative adhesive segments applied one at a time using a single hand to efficiently and reliably secure said gift-wrapping paper.

Having thus described the invention in rather full detail, it will be understood that such detail need not be strictly adhered to, but that additional changes and modifications may suggest themselves to one skilled in the art. For example the tape segments can be provided with adhesive on each side thereof to facilitate joinder of wrapping paper without having the tape being visible. The tear off tab 14 can be provided on each end. Such modifications are intended to fall within the scope of the invention as defined by the subjoined claims.

What is claimed is:

1. A segmented adhesive dispenser system, comprising:
a. a segmented adhesive dispenser composed of a thin polymeric sheet;
b. said segmented dispenser having a surface that is coated with an easy-to-release coating;
c. said segmented dispenser comprising a plurality of adhesive segments;
d. said adhesive segments having a pair of opposing surfaces, the first surface being entirely covered with an adhesive layer adapted to secure wrapping paper and a second surface that is uncolored, colored, patterned or comprises printed text or graphics;
e. said adhesive surface of said segment contacting said easy-to-release surface of said segmented dispenser;
f. a corner or edge of said adhesive segment having an easy-to-release tab, providing a place for grabbing the adhesive segment and easily releasing an adhesive segment underneath said tab during wrapping of a gift; and
g. said adhesive segment providing securing means for said wrapping paper that is substantially completely covered with adhesive, having no adhesive-free dangling areas upon removal of said easy to release tab at the corner or edge of said adhesive segment;
whereby the gift is wrapped quickly and easily by a plurality of decorative adhesive segments to efficiently and reliably secure gift-wrapping paper.

2. A segmented adhesive dispenser system as recited by claim 1, wherein said thin polymeric sheet is a polyester film.

3. A segmented adhesive dispenser system as recited by claim 1, wherein said easy-to-release coating is a silicone coating.

4. A segmented adhesive dispenser system as recited by claim 1, wherein said easy-to-release coating is a wax coating.

5. A segmented adhesive dispenser system as recited by claim 1, wherein said segmented adhesive dispenser is a sheet.

6. A segmented adhesive dispenser system as recited by claim 1, wherein said segmented adhesive dispenser is a roll with continuous wound sheet.

7. A segmented adhesive dispenser system as recited by claim 1, wherein said adhesive segment is transparent.

8. A segmented adhesive dispenser system as recited by claim 1, wherein said adhesive segment is opaque.

9. A segmented adhesive dispenser system as recited by claim 1, wherein said adhesive segments are sequentially applied one at a time to said gift-wrapping in a one handed operation.
